(19) United States
(12) Patent Application Publication
(10) Pub. No.: US 2023/0161831 A1
(43) Pub. Date: May 25, 2023

(54) Systems and Methods for Automatic URL Identification From Data

(71) Applicant: Insurance Services Office, Inc., Jersey City, NJ (US)

(72) Inventors: Swapnil Singh, Bellevue, WA (US); María Dolores Guerrero, Seattle, WA (US); Vasudev Daruvuri, Bothell, WA (US)

(73) Assignee: Insurance Services Office, Inc., Jersey City, NJ (US)

(21) Appl. No.: 17/993,131

(22) Filed: Nov. 23, 2022

Related U.S. Application Data
(60) Provisional application No. 63/282,212, filed on Nov. 23, 2021.

(51) Int. Cl. G06F 16/955; G06F 7/08; G06F 16/2458; G06F 16/2457

(52) U.S. Cl. CPC G06F 16/9566; G06F 7/08; G06F 16/2468; G06F 16/24578

(57) ABSTRACT

Systems and methods for automatic URL identification from data are provided. The system receives and processes one or more sources of data, such as merchant data, and processes the input data to identify one or more URLs present in the data. The identified URLs are automatically validated by the system using one or more fuzzy and/or exact matching algorithms. The validation could be performed by matching one or more non-URL data items, such as a business name, address, e-mail, country, zip code, or any other suitable non-URL data item, to ensure that only valid URLs are identified. Once the URLs are validated, a report is generated by the system.

### RELATED APPLICATIONS

This application claims priority to U.S. Provisional Patent Application Ser. No. 63/282,212 filed on Nov. 23, 2021, the entire disclosure of which is hereby expressly incorporated by reference.

### BACKGROUND

### Field

The present disclosure relates to systems and methods for identifying particular types of data from larger sets of data. More specifically, the present disclosure relates to systems and methods for automatic Uniform Resource Locator (URL) identification from data.

### Related Art

A URL is a specific type of data which identifies a web resource, such as a web page, a File Transfer Protocol (FTP) site, an e-mail, a database, or other web resource. Typically, URLs are used by web browsers to access one or more web pages. URLs are in heavy use in today's web-based and cloud-based computing environments, and follow a specific syntax in order to address a specific web resource.

In various fields, it is very useful to be able to rapidly and accurately identify URLs from large volumes of data. For example, in the retail field, it would be beneficial to provide a computer-based system which can rapidly process large volumes of merchant data, with high precision, to identify one or more merchant URLs. Such merchant URLs, once identified, can be utilized for a variety of purposes, such as monitoring a merchant's online portfolio (accessed via the identified URL) for one or more violations by the merchant, enforcement of agreement terms, etc. Often, URLs are not provided by merchant and other parties to agreements. As a result, the task of identifying merchant URLs (or URLs of other parties) from large volumes of data is performed manually. This results in undue cost as well as lost time.

Accordingly, what would be desirable are systems and methods for automatic URL identification from data, which address the foregoing, and other needs.

### SUMMARY

The present disclosure relates to systems and methods for automatic URL identification from data. The system receives and processes one or more sources of data, such as merchant data, and processes the input data to identify one or more URLs present in the data. The identified URLs are automatically validated by the system using one or more fuzzy and/or exact matching algorithms. The validation could be performed by matching one or more non-URL data items, such as a business name, address, e-mail, country, zip code, or any other suitable non-URL data item, to ensure that only valid URLs are identified. Once the URLs are validated, a report is generated by the system and delivered to a recipient. The report could be electronically transmitted to a recipient data processing system, such as a merchant e-commerce platform.

### BRIEF DESCRIPTION OF THE DRAWINGS

The foregoing features of the invention will be apparent from the following Detailed Description, taken in connection with the accompanying drawings, in which:

FIG. 1 is a flowchart illustrating processing steps carried out by the systems and methods of the present disclosure;

FIG. 2 is a flowchart illustrating the processing steps of FIG. 1, in greater detail;

FIGS. 3-4 are diagrams illustrating sample work flows carried out by the systems and methods of the present disclosure;

FIG. 5 is a diagram illustrating processing phases carried out by the systems and methods of the present disclosure;

FIG. 6 is a table illustrating various validation rules that can be utilized by the systems and methods of the present disclosure to validate identified URLs; and

FIG. 7 is a diagram illustrating sample hardware and software components which can be utilized to implement the systems and methods of the present disclosure.

### DETAILED DESCRIPTION

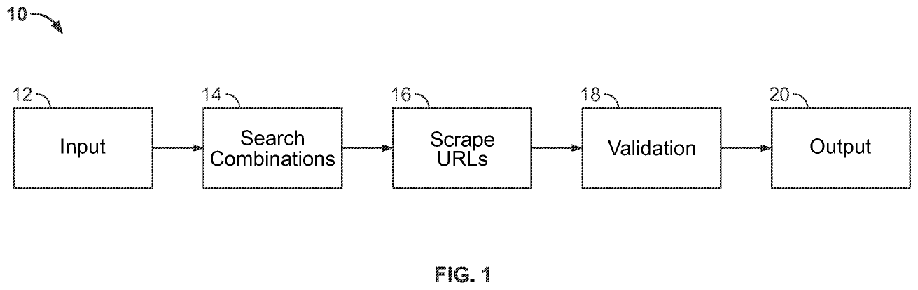

The present disclosure relates to systems and methods for automatic URL identification from data, as discussed in detail below in connection with FIGS. 1-7.

FIG. 1 is a flowchart illustrating processing steps carried out by the systems and methods of the present disclosure, indicated generally at 10. In step 12, the system receives input data to be processed. Such data can be stored in one or more databases (e.g., relational database, etc.) and accessed by and/or transmitted to the system in either CSV or JSON format. Such data can include, but is not limited to, merchant data such as merchant address, zip code, phone number, email, business description, etc. In step 14, the system allows a user to conduct one or more searches through the merchant data using one or more search combinations. For example, the user can search using one or more (or combinations of) the following queries: business name (“Doing Business As” (DBA)), telephone number, postal code, address, city, and any other suitable queries. In step 16, the system searches for (“scrapes” for) one or more matching URLs, using the search combinations identified in step 14. In step 18, the system validates any returned matching URLs using one or more non-URL data items, such as a phone number, an address, a business name, postal code, or other information corresponding to the returned record. If the matching URLs are validated, transmits the matching URLs in step 20. Importantly steps 12-20 can be performed in parallel (e.g., in a multiprocessing environment, using a plurality of processors, processing cores, processing threads, etc.) in order to speed up searching for URLs by the system.

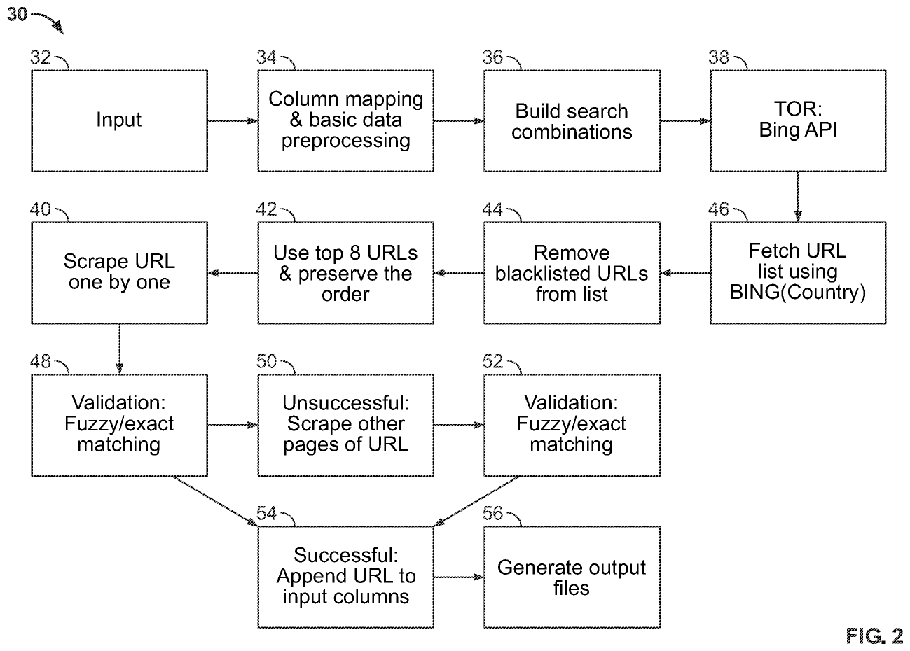

FIG. 2 is a flowchart 30 illustrating the processing steps of FIG. 1 in greater detail. In step 32, the system receives input data to be processed. As noted above, such data can be stored in one or more databases (e.g., relational database, etc.) and accessed by and/or transmitted to the system. In step 34, the system processes the input data using a column mapping process which includes standardization and mapping of incoming columnar metadata to existing column metadata in the system, and also performs any required data preprocessing such as cleaning and standardization of metadata. In step 36, the system allows the user to build one or more search combinations as discussed above in connection with FIG. 1. In step 38, the system accesses a search engine using a suitable web browser and, optionally, an application programming interface (API) call. For example, the system can access the Microsoft Bing search engine using a secure web browser, such as the Tor secure web browser and a suitable API call to the search engine. In step 46, the system fetches a URL list from the search engine via the web browser. Optionally, the URL list could be limited to all URL hits for a particular region, such as in a country. In step 44, the system removes prohibited (“blacklisted”) URLs from the list, if such prohibited URLs exist. In step 42, the system selects the top 8 URLs in the list and preserves the order of the list. Of course, any other number of URLs could be selected.

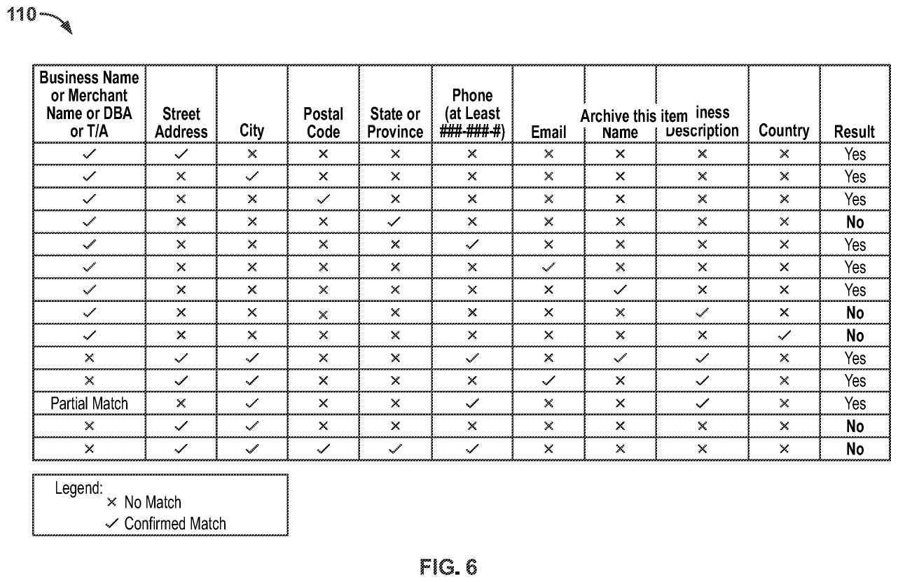

In step 40, the system “scrapes” each URL content including the URL's main page content and the “Contact US” page content in the list (one by one). In step 48, the system validates the incoming metadata (which could be standardized) against URL content using one or more matching algorithms, which could apply fuzzy (approximate) or exact matching processes to the URLs. The matching process follows the logic of FIG. 6 and scores URL content to determine how relevant the scraped URL content is to the merchant metadata. If validation of the URLs is unsuccessful based on the score assigned in the matching process, step 50 occurs, wherein the system scrapes other web pages of the URL. Then, in step 52, the system validates the URL content again using a fuzzy or exact matching process.

If the URLs are successfully validated, step 54 occurs, wherein the system appends the URLs to the input data obtained in step 32. This could be performed by appending the URLs to columns of data in the input data. Finally, in step 56, the system generates and transmits an output file which includes the URLs and the input data.

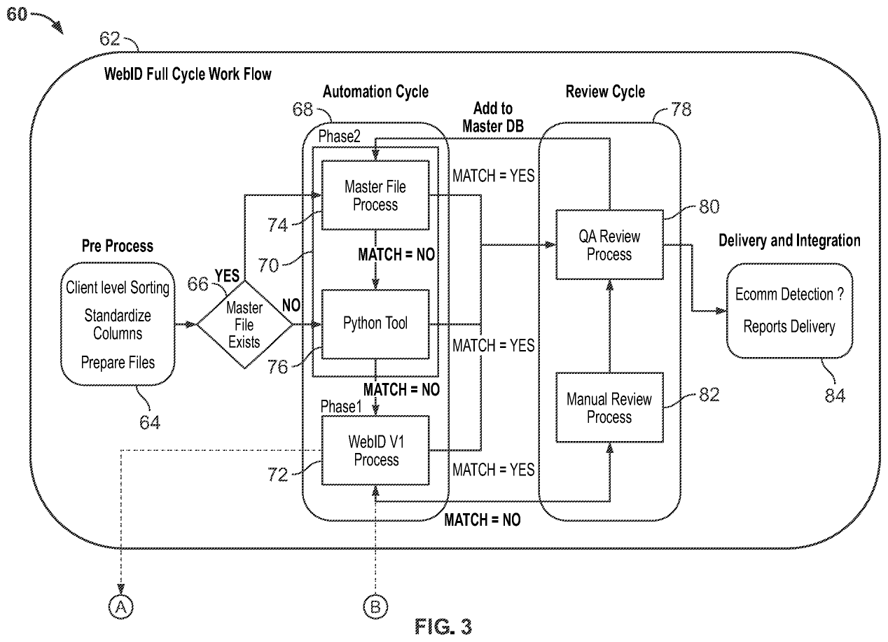

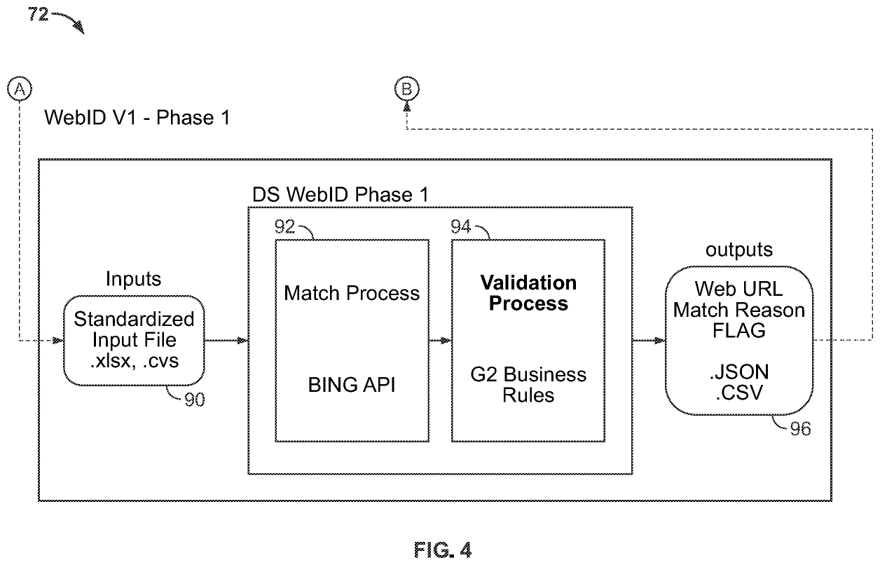

FIGS. 3-4 are diagrams illustrating sample workflows carried out by the systems and methods of the present disclosure. As shown in the workflow 60 of FIG. 3, the system executes a full-cycle work flow 62, which includes a pre-processing step 64, an automation cycle 68, a review cycle 78, and a delivery and integration step 84. Specifically, in pre-processing step 64, the system carries out one or more pre-processing steps on the input data, including, but not limited to, client-level sorting, standardization of columns, and preparation of files. In step 66, the system determines whether a master file exists. If so, step 74 of the automation cycle occurs, wherein the master file is retrieved and processed by the system. Then, in step 76, a python tool is executed, which is a predefined process that looks up incoming merchant metadata and validates the metadata against IP addresses stored in a database. This process also involves strict look-up and cross-checking of URL addresses based on one or more of a business name and an e-mail. Then, step 72 occurs, wherein further processing of the master file occurs as discussed below in connection with FIG. 4.

The review cycle 78 includes a quality assurance (QA) review process 80, wherein the system reviews and confirms the accuracy of the URLs returned by the system. In step 82, the system also optionally allows for a manual review process, wherein one or more users of the system can manually review and confirm the accuracy of URLs returned by the system. In step 84, once the QA review process 80 is complete, the system generates and delivers a report that includes and summarizes all of the URLs returned by the system. Optionally, in step 80, the system can determine whether an e-commerce platform is in communication with the system of the present disclosure.

As shown in the workflow 72 of FIG. 4, the system performs the URL identification processes discussed above in connection with FIGS. 1-2. Specifically, in step 90, the system obtains a standard input file, which could be stored in any suitable format such as an Excel spreadsheet, a comma-separated value (CSV) file, etc. In step 92, the system performs the match processes discussed above in connection with FIGS. 1-2 (e.g., in connection with a search engine such as the Microsoft Bing search engine or any suitable search engine). Then, in step 94, the system performs the validation processes discussed above in connection with FIGS. 1-2. Finally, in step 96, the system generates an output file in a suitable format (which includes the identified URLs), including, but not limited to, a .JSON file, a .CSV file, or any other suitable format. Additionally, it is noted that the system can flag one or more of the URL results, and/or generate a reason as to why the URL match was identified.

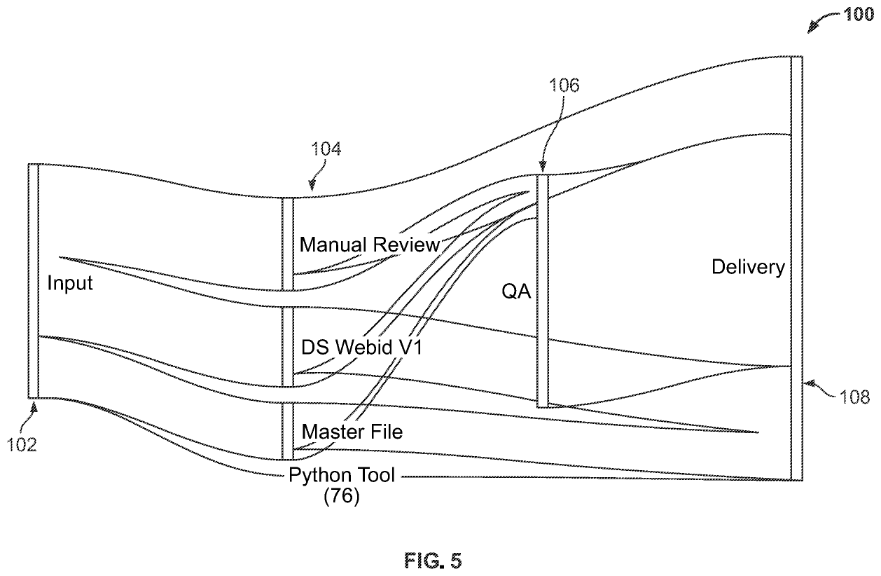

FIG. 5 is a diagram 100 illustrating processing phases carried out by the systems and methods of the present disclosure. The processes include the input processes 102 discussed above in connection with FIGS. 1-4, one or more parallel processes 104, which could include the manual review process, the system processes discussed in connection with FIGS. 1-4, and one or more master files. Additionally, the parallel processes 104 could also include the python tool 76 discussed above. Advantageously, since the processes 104 could be carried out in parallel, system processing speed is greatly increased. The process 106 allows for quality assurance (QA) processes discussed above in connection with FIG. 3. Finally, in process 108, the results are delivered by the system (e.g., electronically in a file/report).

FIG. 6 is a table 110 illustrating various validation rules that can be utilized by the systems and methods of the present disclosure to validate identified URLs. Examples of various criteria that can be used to validate the URLs include, but are not limited to, business or merchant name or DBA name or “transacting business as” (T/A) name, street address, city, postal code, state or province, telephone number, e-mail, name, business description, or country. Any desired combinations can be used, and can be toggled as desired in order to “tweak” the validation processes and/or accuracy thereof.

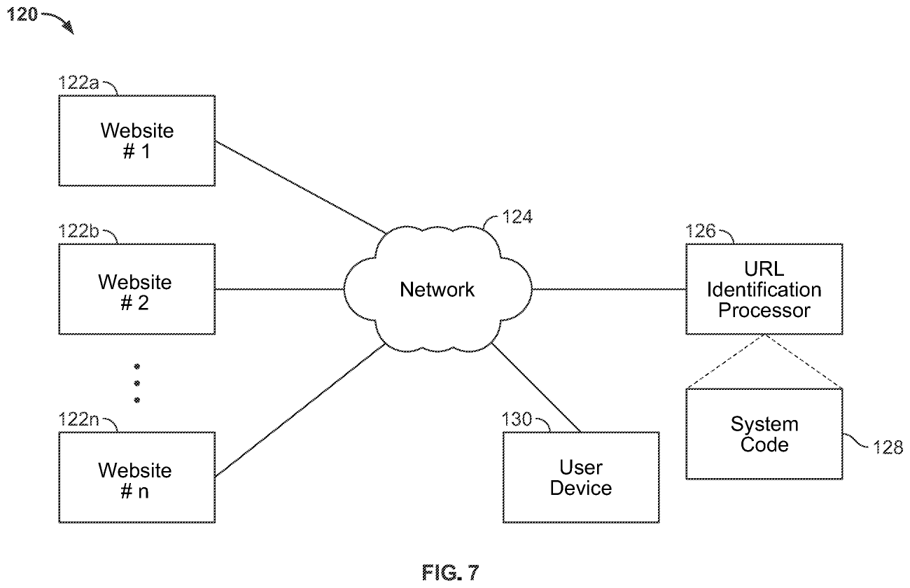

FIG. 7 is a diagram 120 illustrating sample hardware and software components which can be utilized to implement the systems and methods of the present disclosure. The system can scrape URL information from one or more websites 122a-122n (n being any desired number), which can communicate with a URL identification processor 126 via a network connection 124 (e.g., the Internet, a wide area network (WAN), a local area network (LAN), a wireless network, an optical network, etc.). The URL identification processor 126 could include a hardware processor such as a computer system, computer server, cloud processing service, mobile device, etc., which executes system code 128 programmed in accordance with the processes discussed herein in connection with FIGS. 1-6. The system code 128 could comprise non-transitory, computer-readable code stored on one or more computer-readable media capable of being accessed by the processor 126, including, but not limited to, random-access memory (RAM), read-only memory (ROM), electrically-erasable programmable ROM (EEPROM), non-volatile (NV) memory, flash memory, disk storage, tape storage, or any other suitable memory capable of being accessed by the processor 126. Additionally and/or alternatively, the systems and methods discussed herein could be implemented as one or more customized hardware components such as an application-specific integrated circuit (ASIC), a field-programmable gate array (FPGA), or any other suitable customized hardware component.

Having thus described the system and method in detail, it Is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A method for automatic identification of a Uniform Resource Locator (URL) from data, comprising the steps of:
receiving a data item at a processor;
processing the data idem to identify at least one URL present in the data item;
processing the at least one URL using at least one of a fuzzy matching algorithm or an exact matching algorithm to validate the at least one URL; and
if the at least one URL is validated by the fuzzy matching algorithm or the exact matching algorithm, generating and transmitting an output file that includes the at least one URL.

2. The method of claim 1, further comprising matching one or more non-URL data items to ensure that only valid URLs are identified.

3. The method of claim 1, further comprising pre-processing the data item to perform at least one of sorting the data item according to a client-level sorting or standardizing columns in the data item.

4. The method of claim 1, further comprising identifying merchant metadata associated with the data item and validating the merchant metadata against one or more IP addresses.

5. The method of claim 4, further comprising cross-checking the at least one URL based on one or more of a business name or an e-mail address.

6. The method of claim 1, further comprising validating the at least one URL utilizing at least one matching criteria including one or more of a business name, a merchant name, a doing business as (DBA) name, a transacting business as (T/A) name, a street address, a city, a postal code, a state, a province, a telephone number, an e-mail address, a name, a business description, or a county.

7. The method of claim 1, further comprising scoring the at least one URL to determine relevancy of the at least one URL to metadata associated with a merchant.

8. A system for automatic identification of a Uniform Resource Locator (URL) from data, comprising:
a database storing at least one data item; and
a processor in communication with the database, the processor programmed to perform the steps of:
receiving the data item;
processing the data idem to identify at least one URL present in the data item;
processing the at least one URL using at least one of a fuzzy matching algorithm or an exact matching algorithm to validate the at least one URL; and
if the at least one URL is validated by the fuzzy matching algorithm or the exact matching algorithm, generating and transmitting an output file that includes the at least one URL.

9. The system of claim 8, wherein the processor is programmed to perform the step of matching one or more non-URL data items to ensure that only valid URLs are identified.

10. The system of claim 8, wherein the processor is programmed to perform the step of pre-processing the data item to perform at least one of sorting the data item according to a client-level sorting or standardizing columns in the data item.

11. The system of claim 8, wherein the processor is programmed to perform the step of identifying merchant metadata associated with the data item and validating the merchant metadata against one or more IP addresses.

12. The system of claim 11, wherein the processor is programmed to perform the step of cross-checking the at least one URL based on one or more of a business name or an e-mail address.

13. The system of claim 8, wherein the processor is programmed to perform the step of validating the at least one URL utilizing at least one matching criteria including one or more of a business name, a merchant name, a doing business as (DBA) name, a transacting business as (T/A) name, a street address, a city, a postal code, a state, a province, a telephone number, an e-mail address, a name, a business description, or a county.

14. The system of claim 8, wherein the processor is programmed to perform the step of scoring the at least one URL to determine relevancy of the at least one URL to metadata associated with a merchant.

15. A non-transitory, computer-readable medium having computer-readable instructions stored thereon which, when executed by a processor, causes the processor to perform the steps of:
receiving a data item at the processor;
processing the data idem to identify at least one URL present in the data item;
processing the at least one URL using at least one of a fuzzy matching algorithm or an exact matching algorithm to validate the at least one URL; and
if the at least one URL is validated by the fuzzy matching algorithm or the exact matching algorithm, generating and transmitting an output file that includes the at least one URL.

16. The computer-readable medium of claim 15, further comprising instructions for causing the processor to perform the step of matching one or more non-URL data items to ensure that only valid URLs are identified.

17. The computer-readable medium of claim 15, further comprising instructions for causing the processor to perform the step of pre-processing the data item to perform at least one of sorting the data item according to a client-level sorting or standardizing columns in the data item.

18. The computer-readable medium of claim 15, further comprising instructions for causing the processor to perform the step of identifying merchant metadata associated with the data item and validating the merchant metadata against one or more IP addresses.

19. The computer-readable medium of claim 18, further comprising instructions for causing the processor to perform the step of cross-checking the at least one URL based on one or more of a business name or an e-mail address.

20. The computer-readable medium of claim 15, further comprising instructions for causing the processor to perform the step of validating the at least one URL utilizing at least one matching criteria including one or more of a business name, a merchant name, a doing business as (DBA) name, a transacting business as (T/A) name, a street address, a city, a postal code, a state, a province, a telephone number, an e-mail address, a name, a business description, or a county.

21. The computer-readable of claim 15, further comprising instructions for causing the processor to perform the step of scoring the at least one URL to determine relevancy of the at least one URL to metadata associated with a merchant.
